(19) United States
(12) Patent Application Publication
(10) Pub. No.: US 2024/0362472 A1
(43) Pub. Date: Oct. 31, 2024

(54) AUTOMATED HANDLING OF DATA DRIFT IN EDGE CLOUD ENVIRONMENTS

(71) Applicant: Telefonaktiebolaget LM Ericsson (publ), Stockholm (SE)

(72) Inventors: Chunyan Fu, Pointe-Claire (CA); Behshid Shayesteh, Montreal (CA); Amin Ebrahimzadeh, LaSalle (CA); Roch Glitho, Ville Saint Laurent (CA)

(73) Assignee: Telefonaktiebolaget LM Ericsson (publ), Stockholm (SE)

(21) Appl. No.: 18/285,367

(22) PCT Filed: Apr. 5, 2021
(86) PCT No.: PCT/IB2021/052815

§ 371 Date: Oct. 2, 2023

(51) Int. Cl. G06N 3/08

(52) U.S. Cl. CPC G06N 3/08

(57) ABSTRACT

A computer-implemented method for automated handling of data drift in a machine learning (ML) system including a plurality of trained ML models is provided. The method includes obtaining performance metrics requirements used for data drift handling; monitoring an input data stream of the ML system, wherein the monitoring includes a first monitoring for detecting data drift based on a distribution change of the input data and for determining a type and a range of data drift, and a second monitoring for detecting data drift based on a drop in accuracy of a first trained ML model; if the first monitoring and the second monitoring both detect data drift, selecting from a data repository storing a plurality of data drift adaptors one of the data drift adaptors based on the performance metrics requirements obtained, a type of the first trained ML model, and the determined type and range of data drift; testing the selected data drift adaptor to determine if the performance metrics requirements are met; and if the performance metrics requirements are met, applying the selected data drift adaptor to the first trained ML model to adapt the first trained ML model to handle the data drift.

### TECHNICAL FIELD

Disclosed are embodiments related to automated handling of data drift in edge cloud environments.

### BACKGROUND

Artificial Intelligence/Machine Learning (AI/ML) technologies are often used for edge cloud management tasks, such as fault management and performance management. A trained AI/ML model requires its input data to be stationary to perform well. This requirement can hardly be fulfilled when an AI/ML model is applied to edge clouds, which usually show high dynamicity in configurations and workloads.

Consequentially, the distribution of the data collected from the edge environment is subject to change over time frequently, which is commonly referred to as concept drift (see, e.g., G. Widmer and M. Kubat, “Learning in the presence of concept drift and hidden contexts,” Machine learning, vol. 23, no. 1, pp. 69-101, November 1996) or data drift. Such drifts, if not handled properly, will significantly downgrade the performance of an AI/ML model.

Edge cloud operators would like to keep benefitting from accurate inferencing results provisioned by the AI/ML technologies, while they want to save the cost of the overall management overhead. On the other hand, in a large-scale heterogeneous edge cloud system, the impacts of drifts on AI/ML models show high diversity, which results in the complexity of handling the drift case by case. Thus, there is a need for managing the concept drift in a more systematic way in edge cloud, which shall, to a large extent, automate the handling process while considering the given resource and performance requirements of the operator.

There are five types of data drift previously identified: outliers, abrupt drifts, re-occurring drifts, gradual drifts and incremental drifts, where the outliers are usually random turbulence and do not need to be handled. The other four types need to be managed and the technologies such as partial model update, for example, transfer learning (TL) (see, e.g., J. Yosinski, J. Clune, Y. Bengio, and H. Lipson, “How transferable are features in deep neural networks?” in Advances in Neural Information Processing Systems, December 2014, pp. 3320-3328), incremental ensemble learning (see, e.g., Y. Sun, K. Tang, Z. Zhu, and X. Yao, “Concept drift adaptation by exploiting historical knowledge,” IEEE Transactions on Neural Networks and Learning Systems, vol. 29, no. 10, pp. 4822-4832 February 2018), model retraining, and data compensation are used for handling them.

When solving the problem of concept drift for a specific model in a specific environment, ML experts need to analyze the range and type of the drifted data, choose the proper technology for drift adaptation, and determine the amount of data to be used for drift adaptation.

### SUMMARY

While there are numerous methods for handling concept drift in ML models, for example, transfer learning, incremental ensemble learning, model retraining and data compensation, the underlying processes often require manual intervention/input. Requiring manual input/involvement raises scalability issues especially for large-scaled distributed cloud environments. This mandates the need for designing an automated concept drift handler for heterogeneous edge cloud environments that compensates any concept drift that may occur in the system in a cost-efficient manner while minimizing the amount of human involvement.

Embodiments disclosed herein address this need by providing a method that automatically selects and applies a concept drift adaptation method in edge cloud. It takes the operator's resource, time, and model accuracy requirements into consideration and selects the most appropriate concept drift adaptation method among the given multiple methods based on the type of running ML models and the type and range of the data drift. It also automatically learns the amount of data to be used for adaptation using reinforcement learning.

Embodiments disclosed herein solve the concept drift problem for AI/ML models in order to ensure the persistent accuracy of the models, thus enhancing the performance of the edge site management. Considering both resource and time requirements of the operator, the methods of the embodiments disclosed herein achieve a balance between the AI/ML model performance and resource usage.

Embodiments disclosed herein automate the adaptation method selection, thus saving the cost of manual selection and testing. The novel methods of embodiments disclosed herein allow policy adjustment for data drift method selection, giving an operator the flexibility of adding new concept drift adaptation methods and new selection criteria. Methods of the embodiments disclosed herein run autonomously on, for example, each edge site, enabling deployment in large-scale, heterogeneous edge cloud environments.

According to a first aspect, a computer-implemented method for automated handling of data drift in a machine learning (ML) system including a plurality of trained ML models is provided. The method includes obtaining performance metrics requirements used for data drift handling; monitoring an input data stream of the ML system, wherein the monitoring includes a first monitoring for detecting data drift based on a distribution change of the input data and for determining a type and a range of data drift, and a second monitoring for detecting data drift based on a drop in accuracy of a first trained ML model; if the first monitoring and the second monitoring both detect data drift, selecting from a data repository storing a plurality of data drift adaptors one of the data drift adaptors based on the performance metrics requirements obtained, a type of the first trained ML model, and the determined type and range of data drift; testing the selected data drift adaptor to determine if the performance metrics requirements are met; and if the performance metrics requirements are met, applying the selected data drift adaptor to the first trained ML model to adapt the first trained ML model to handle the data drift.

In some embodiments, the testing includes: determining an amount of the input data to collect; collecting the determined amount of input data; using the collected input data as input to a second trained ML model; applying the selected data drift adaptor to the second trained ML model; and determining whether the performance metrics requirements are met based on output values from the second trained ML model.

In some embodiments, the performance metrics requirements include one or more of a maximum time used for drift adaptation, a maximum amount of resources allocated for drift adaptation, a maximum amount of dataset size used for drift adaptation, and an ML model target accuracy tolerance range.

In some embodiments, the first monitoring for detecting data drift based on a distribution change of the input data includes mapping at least one training window to at least one feature and at least one corresponding drift time of the at least one feature; detecting whether at least one feature is drifting during at least one data window, the at least one data window being based at least in part on the at least one training window that is mapped to the at least one feature; estimating at least one next value and a distribution of at least one feature based on the input data stream; and predicting whether at least one feature is drifting based at least in part on at least one predetermined drift pattern and the estimated next value and the distribution.

In some embodiments, the first monitoring for determining the type of data drift includes predicting the data drift in the input data stream, wherein the at least one predetermined drift pattern includes one or more of a sudden drift pattern, a gradual drift pattern, an incremental drift pattern and a reoccurring drift pattern. In some embodiments, the first monitoring for determining the range of data drift includes determining whether an amount of the at least one of the detected data drift and the predicted data drift at least meets or exceeds a predetermined drift threshold.

In some embodiments, the second monitoring for detecting data drift based on a drop in accuracy of the first trained ML model includes using one or more of: Cumulative Sum (CUSUM) method, Adaptive Window (ADWIN) method, Early Drift Detection Method (EDDM), and Fast Hoeffding Drift Detection Method (FHDDM).

In some embodiments, selecting from the data repository one of the data drift adaptors based on the performance metrics requirements obtained, the type of the first trained ML model, and the determined type and range of data drift includes using reinforcement learning (RL). In some embodiments, the RL used includes policy-based RL and the selecting includes defining a first state and a second state for target accuracy, wherein, in the first state, the target accuracy is within a predetermined target accuracy tolerance range and, in the second state, the target accuracy is not within the predetermined target accuracy tolerance range; defining actions of selecting each one of the data drift adaptors from the plurality of data drift adaptors in the data repository; defining a reward function based on the target accuracy, time consumption, and resource consumption of the selected one of the data drift adaptors; and defining a policy function based on a probability distribution of taking each action.

In some embodiments, the selecting further includes (a) applying the policy function to provide the probability distribution of all actions; (b) performing the action with the highest probability; (c) applying the reward function to provide the reward value for the action performed; (d) updating the probability distribution of the policy function based on the reward value for the action performed; performing steps (a) to (d) until the policy converges; and selecting the data drift adaptor with the highest probability or, if the policy has not converged, continuing to perform steps (a) to (d) until expiration of a predetermined time period, after which the data drift adaptor with the highest probability is selected.

In some embodiments, determining an amount of the input data to collect includes using reinforcement learning (RL) and the determining includes initializing a data size range; initializing states, each state corresponding to one candidate data size of a plurality of candidate data sizes within the data size range; initializing a first action of increasing the data size and a second action of decreasing the data size; and defining a reward function based on a gained accuracy using collected data and target accuracy.

In some embodiments, determining an amount of the input data to collect further includes (a) based on the reward value in Q, determining whether to perform the first action or the second action; (b) selecting one action; (c) update the reward values in Q for the selected action; performing steps (a) to (c) for each candidate data size; and identifying the candidate data size with the highest reward value above a predetermined threshold reward value for the amount of data to be collected or, if no reward value is above the predetermined threshold value, continuing to perform steps (a) to (c) for each candidate data size until expiration of a predetermined time period, after which the candidate data size with the highest reward value is identified as the data size for the amount of data to be collected.

In some embodiments, the RL includes Q-learning. In some embodiments, the monitoring further includes monitoring the accuracy of the first and/or second trained ML models.

According to a second aspect, a machine learning (ML) system is provided. The ML system includes processing circuitry and a memory containing instructions executable by the processing circuitry for automated handling of data drift. The ML system includes a plurality of trained ML models and is operative to obtain performance metrics requirements used for data drift handling and monitor an input data stream of the ML system. The monitoring includes a first monitoring for detecting data drift based on a distribution change of the input data and for determining a type and a range of data drift; and a second monitoring for detecting data drift based on a drop in accuracy of a first trained ML model. If the first monitoring and the second monitoring both detect data drift, the ML system is further operative to select from a data repository storing a plurality of data drift adaptors one of the data drift adaptors based on the performance metrics requirements obtained, a type of the first trained ML model, and the determined type and range of data drift; test the selected data drift adaptor to determine if the performance metrics requirements are met; and if the performance metrics requirements are met, apply the selected data drift adaptor to the first trained ML model to adapt the first trained ML model to handle the data drift.

According to a third aspect, a node is provided. The node configured for automated handling of data drift in a network using the machine learning (ML) system of the second aspect.

According to a fourth aspect, a computer program is provided. The computer program includes instructions which when executed by processing circuitry causes the processing circuitry to perform the method of any one of the embodiments of the first aspect.

According to a fifth aspect, a carrier is provided. The carrier contains the computer program of the fourth aspect and is one of an electronic signal, an optical signal, a radio signal, and a computer readable storage medium.

### BRIEF DESCRIPTION OF THE DRAWINGS

The accompanying drawings, which are incorporated herein and form part of the specification, illustrate various embodiments.

FIG. 1 is a schematic diagram illustrating an exemplary architecture for a machine learning (ML) system according to some embodiments.

FIG. 2 is a schematic diagram illustrating an exemplary architecture for a machine learning (ML) system according to some embodiments.

FIG. 3 is a block diagram illustrating an exemplary ML system architecture according to some embodiments.

FIG. 4 is a flow chart illustrating a process according to some embodiments.

FIG. 5 is a flow chart illustrating a process according to some embodiments.

FIG. 6 is a flow chart illustrating a process for selecting a drift adaptation method according to some embodiments.

FIG. 7 is a flow chart illustrating another process for selecting a drift adaptation method according to some embodiments.

FIG. 8 is a flow chart illustrating a process for data collection according to some embodiments.

FIG. 9 illustrates an exemplary implementation in an edge cloud for the ML system for automated handling of data drift according to some embodiments.

FIG. 10 is a bar chart illustrating the accuracy of different trained ML prediction models used for the exemplary implementation of the ML system in an edge cloud according to some embodiments.

FIG. 11 is a bar chart illustrating the average detection delay of different drift detection methods used for the exemplary implementation of the ML system in an edge cloud according to some embodiments.

FIG. 12 is a bar chart illustrating the accuracy of different trained ML prediction models after adaptation used for the exemplary implementation of the ML system in an edge cloud according to some embodiments.

FIG. 13 is a graph illustrating the accuracy over time of the exemplary implementation of the ML system in an edge cloud according to some embodiments, as compared to an edge cloud without the ML system.

FIG. 14 is a block diagram of an apparatus according to some embodiments.

FIG. 15 is a block diagram of an apparatus according to an embodiment.

### DETAILED DESCRIPTION

In exemplary embodiments of the present disclosure, an operator may manage a large number and type of edge cloud sites using a number of AI/ML technologies. For example, AI/ML models may be used for anomaly detection, fault prediction, and workflow placement. Due to the high dynamicity of the configuration and workflow on an edge site, the distribution of the data changes over time, which results in an AI/ML model performance drop.

Embodiments disclosed herein provide a solution that automatically selects a data drift adaptation method among multiple methods to handle a data drift. In exemplary embodiments, the selection considers the operator's data drift adaptation requirements and the decision is based on the type of running ML models and the type and range of the data drift. The selection process can adapt to the operator's requirement changes and the adaptation method changes (e.g., add, remove). Methods of the embodiments disclosed herein also automatically determine the amount of data required for handling the data drift.

Embodiments of the present disclosure include a drift handling controller that receives the drift handling requirements from an operator and initializes a drift adaptation method selector, which is responsible for selecting a drift adaptation method that fulfills the drift handling requirements based on, for example, policy-based reinforcement learning, from a drift adaption method repository. The drift adaptation method selector also instantiates the selected drift adaptor and initializes a data collector, which learns the amount of data to collect and then collects the data for the drift adaptor.

Before describing in detail exemplary embodiments, it is noted that the embodiments reside primarily in combinations of apparatus components and processing steps related to detection, prediction and/or compensation of data drift in distributed clouds. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

In some embodiments, the term “raw data” is used herein and refers to the data collected from a monitored system. Raw data is usually preprocessed in order for a machine learning model to use. The preprocessing procedures may include removing empty data samples, inputting missing data samples, and normalizing the data, etc.

In some embodiments, the term “data stream” (or streamed data) is used herein and refers to a sequence of packets of data or data packets used to transmit or receive information that is in the process of being transmitted from a monitored system. The “data stream” may also be called “online data” in some contexts. Online data may contain one or multiple data samples at a time and is usually used by a trained machine learning model for inferring a real-time system status.

Online data is contrast to the “offline data,” which is collected offline, containing a batch of data samples and being stored in a data repository. Offline data is often used for training, testing and validating machine learning models.

In some embodiments, the term “stationary data” is used herein and refers to the data whose mean, variance and autocorrelation structure does not significantly change over time. In contrast, drifted/drifting data is considered as “non-stationary data.”

In some embodiments, the term “data window” (or a window of data) is used herein and refers to a defined time range for data collection. For example, given a window of 10 minutes, data from the previous 10 minutes can be collected from a monitored system at a time. A window can slide. For example, if online data is collected every 10 seconds with a window size of 10 minutes, then the 10 minutes' window is considered to “slide” forward every 10 second interval. Sliding window is a technique that is often used for time series predictions.

In some embodiments, the term “training window” is used herein and refers to the time range/interval for collecting training data. For example, a training window of 1 hour, 1 day, 1 week or 1 month means that training data has been collected for 1 hour, 1 day, 1 week or 1 month, respectively.

The terms “concept drift,” “data drift,” and “drift” are used interchangeably herein.

The term “feature” is used herein and is an input used for machine learning. For example, with respect to a dataset table or matrix, the features may be a column in the dataset table. A feature may represent an observable attribute/quality and a value combination (e.g., rank of value 2).

As used herein, the term “drift time” is used herein and may indicate a time that or during which a feature is detected to drift and/or a time that or during which a feature is predicted to drift.

The term “machine learning (ML) system” used herein can be any kind of ML system, such as, for example, a computing device, one or more processors, one or more processing circuitries, a machine, a mobile wireless device, a user equipment, a central processing unit (CPU), a graphics processing unit (GPU), a field programmable gate array (FPGA), a server, a network node, a base station, etc. that may implement one or more machine learning models and, in particular, may apply one or more of the techniques disclosed herein to detect, predict and/or compensate for data drift.

Note that although some of the embodiments are described with reference to data processing in the cloud, it should be understood that the techniques disclosed herein may be beneficial and applicable to other types of machine learning problems and/or systems in which data drift is experienced.

Any two or more embodiments described in this disclosure may be combined in any way with each other.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

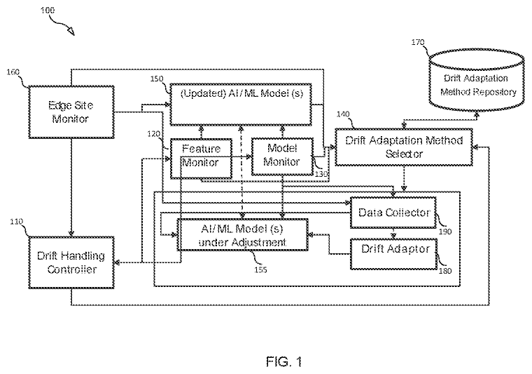

Referring now to FIG. 1, FIG. 1 is a schematic diagram illustrating an exemplary architecture for a ML system 100 according to some embodiments. The ML system 100, in accordance with some embodiments of the present disclosure, is implemented by or deployed in a communication system in, for example, a distributed cloud environment. Embodiments of the present disclosure are not limited to being implemented by or deployed in a communication system, such as a distributed cloud environment, and may be implemented by or deployed in one or more other systems and/or networks. Embodiments of the present disclosure include an ML system 100 that automatically handles the data drift in, for example, an edge site.

Referring to FIG. 1, in some embodiments, the ML system 100 includes a drift handling controller 110 for obtaining performance metrics requirements, such as drift handling requirements' key performance indicators (KPIs) from, for example, an operator. In some embodiments, the drift handling controller 110 initializes a feature monitor 120 and a model monitor 130 for monitoring an input data stream of the ML system for data drift detection, and initializes a drift adaptation method selector 140, which is responsible for selecting a drift adaptor 180 that fulfills the drift handling requirements. The feature monitor 120 monitors the distribution changes of the AI/ML model input data, while the model monitor 130 monitors the model accuracy drops.

In some embodiments, the feature monitor 120 detects data drift based on a distribution change of the input data and determines a type and a range of data drift. The feature monitor 120 may detect data drift based on a distribution change of the input data by mapping at least one training window to at least one feature and at least one corresponding drift time of the at least one feature, detecting whether at least one feature is drifting during at least one data window, the at least one data window being based at least in part on the at least one training window that is mapped to the at least one feature, estimating at least one next value and a distribution of at least one feature based on the input data stream, and predicting whether at least one feature is drifting based at least in part on at least one predetermined drift pattern and the estimated next value and the distribution. The feature monitor 120 may determine the type of data drift by predicting the data drift in the input data stream, wherein the at least one predetermined drift pattern includes one or more of a sudden drift pattern, a gradual drift pattern, an incremental drift pattern and a reoccurring drift pattern. The feature monitor 120 may determine the range of data drift by determining whether an amount of the at least one of the detected data drift and the predicted data drift at least meets or exceeds a predetermined drift threshold.

In some embodiments, the model monitor 130 detects data drift based on a drop in accuracy of a first trained ML model 150. The model monitor 130 may detect data drift based on a drop in accuracy of the first trained ML model 150 using one or more of: Cumulative Sum (CUSUM) method, Adaptive Window (ADWIN) method, Early Drift Detection Method (EDDM), and Fast Hoeffding Drift Detection Method (FHDDM).

The feature monitor 120 and the model monitor 130 work together, and a data drift alert is issued only when both monitors detect a drift. The feature monitor 120 is also responsible for providing the data drift type and range information. The type of a drift may be obtained via an ML classifier that is trained in a supervised way to tell different drift patterns. The range of drift can be calculated by e.g., comparing the original and current data means and deviations.

In some embodiments, if the feature monitor 120 and the model monitor 130 both detect data drift, the drift adaptation method selector 140 selects, from a drift adaptation method repository 170 storing a plurality of data drift adaptors, one of the data drift adaptors 180 based on the performance metrics requirements obtained, a type of the first trained ML model 150, and the determined type and range of data drift. Once a data drift is detected by the feature monitor 120 and the model monitor 130, a drift detection alert, together with the drift type and drift range, is sent to the drift adaptation method selector 140. The drift adaptation method selector 140 then collects the AI/ML model information and the edge site resource information from the AI/ML model 150 and the edge site monitor 160, respectively. Based on all the information, it searches and selects from the drift adaption method repository 170, the most appropriate drift adaptor 180.

In some embodiments, the drift adaption method repository 170 stores the executable drift adaptors and allows the drift adaptation method selector 140 to search for a drift adaptor by AI/ML model type and drift adaption method. For example, a ‘cnn-TL-1’ is searchable by keywords: convolutional neural network (CNN), transfer learning (TL) and layer 1 adjustment. The drift adaption method repository 170 can, for example, be distributed in multiple edge sites or be centrally located in a data center.

The selecting from the drift adaptation method repository 170 based on the performance metrics requirements obtained, a type of the first trained ML model 150, and the determined type and range of data drift may use reinforcement learning (RL) and the RL used may include Q-learning. The RL used may include policy-based RL and the selecting may include defining a first state and a second state for target accuracy, wherein, in the first state, the target accuracy is within a predetermined target accuracy tolerance range and, in the second state, the target accuracy is not within the predetermined target accuracy tolerance range, defining actions of selecting each one of the data drift adaptors from the plurality of data drift adaptors in the drift adaptation method repository 170, defining a reward function based on the target accuracy, time consumption, and resource consumption of the selected one of the data drift adaptors, and defining a policy function based on a probability distribution of taking each action. The selecting may further include (a) applying the policy function to provide the probability distribution of all actions, (b) performing the action with the highest probability, (c) applying the reward function to provide the reward value for the action performed, (d) updating the probability distribution of the policy function based on the reward value for the action performed, performing steps (a) to (d) until the policy converges; and selecting the data drift adaptor with the highest probability or, if the policy has not converged, continuing to perform steps (a) to (d) until expiration of a predetermined time period, after which the data drift adaptor with the highest probability is selected.

In some embodiments, a data collector 190 tests the selected data drift adaptor 180 to determine if the performance metrics requirements are met. After a drift adaptor 180 is selected, the drift adaptation method selector 140 will instantiate the drift adaptor 180, which will execute the actual drift adaptation—for example, a transfer learning function that adjusts the first layer of a neural network. Together with the drift adaptor 180, the drift adaptation method selector 140 will initiate the data collector 190, which is responsible for collecting data for the drift adaptor 180. The data collector 190 automatically learns the amount of data to collect using reinforcement learning (RL) or evolutionary methods, such as genetic algorithm. The data collector may learn the amount of data to collect using RL Q-learning.

The testing may include determining an amount of the input data to collect, collecting the determined amount of input data, using the collected input data as input to a second trained ML model 155, applying the selected data drift adaptor 180 to the second trained ML model 155, and determining whether the performance metrics requirements are met based on output values from the second trained ML model 155. Determining an amount of the input data to collect may include using RL and initializing a data size range, initializing states, each state corresponding to one candidate data size of a plurality of candidate data sizes within the data size range, initializing a first action of increasing the data size and a second action of decreasing the data size, and defining a reward function based on a gained accuracy using collected data and target accuracy. Determining an amount of the input data to collect may further include (a) based on the reward value in Q, determining whether to perform the first action or the second action; (b) selecting one action; (c) update the reward values in Q for the selected action, performing steps (a) to (c) for each candidate data size, and identifying the candidate data size with the highest reward value above a predetermined threshold reward value for the amount of data to be collected or, if no reward value is above the predetermined threshold value, continuing to perform steps (a) to (c) for each candidate data size until expiration of a predetermined time period, after which the candidate data size with the highest reward value is identified as the data size for the amount of data to be collected.

In some embodiments, applying the adaptation to the online management AI/ML model may include: (a) transfer learning, e.g., retrain the first layer of the AI/ML model under adjustment 155, such as a neural network, retrain the last layer of the neural network 155, retrain any layer(s) in the middle of the neural network 155; (b) retrain the whole AI/ML model under adjustment 155; or (c) ensemble the partially retrained AI/ML model under adjustment 155 with the first AI/ML model 150. Once the adapted model 155 meets the accuracy requirement, replace the model 150 with model 155 for online inferencing.

In some embodiments, the drift handling controller 110 collects model performance from the model monitor 130 and the resource utilization status from the edge site monitor 160, and evaluates the performance of the last adaptation. The drift handling controller 110 evaluates if the adapted model fulfills the accuracy requirement and the resource utilization requirement when online inferencing and provides feedback to the operator. This can be done, for example, by comparing the average model accuracy collected from the model monitor 130 to the accuracy requirement defined by the operator, and comparing the average model resource utilization collected from edge site monitor 160 to the resource utilization requirement defined by the operator, and then generating, for example, a report.

In some embodiments, adjustments or changes may be made by, for example, an operator, to the drift handling KPI requirements or to the drift adaptation method repository 170 by adding a new type of data drift adaptation method or drift adaptor. When such adjustments or changes are made, the parameters in the drift adaptation method selector will get updated accordingly.

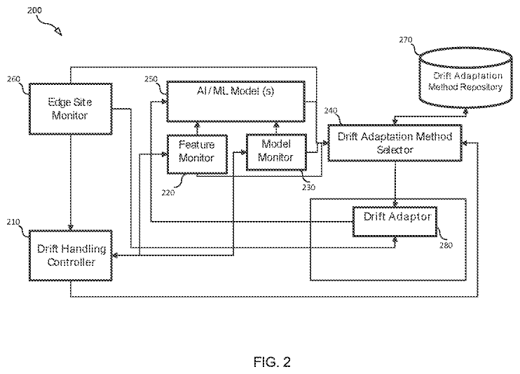

Referring now to FIG. 2, a schematic diagram illustrating an exemplary architecture for an ML system 200 according to some embodiments with data compensation as the drift adaptation method or drift adaptor 280 selected.

Using data compensation for handling predicted drift is disclosed in WO2021044192. More specifically, WO2021044192 describes an ML system that detects, predicts and/or compensates for data drift, and includes an original, trained ML model and one or more components that can be used to detect, predict and/or compensate for data drift in an input data stream/online data of the ML model using techniques, such as, one or more of a training learner, drift detector, drift predictor, and compensator. As described in WO2021044192, the drift detector can identify whether a feature is drifting or not according to an obtained features map and data window size. The drift predictor may be configured to estimate the values of the next data samples for the different features using, for example, Naïve Bayes, autoregressive integrated moving average (ARIMA), recurrent neural network (RNN) and convolutional neural networks (CNN). The drift predictor can predict the data drift using the estimated values of features and known drift patterns, such as one or more of sudden, incremental, reoccurring and gradual drift patterns. The compensator may compensate the drift of online data/features to be used as input for the ML model. The compensator may be configured to determine a compensation function, the compensation function configured to offset at least part of the data drift, the compensation function being based at least in part on the at least one of the detecting and the predicting

The accuracy of the drift detector disclosed in WO2021044192 mainly relies on the size of the training window, which is set manually. Also, the compensation learner component disclosed in WO2021044192 is not auto-adaptive in a sense that it does not provide any instruction on how to select the most appropriate drift handling method according to the unique features of the edge node (i.e., delay and/or resource sensitivity), as well as the type of drift.

In embodiments of the present disclosure, the ML system 200 includes a drift handling controller 210 for obtaining performance metrics requirements, such as drift handling requirements' key performance indicators (KPIs) from, for example, an operator. The drift handling controller 210 initializes a feature monitor 220 and a model monitor 230 for monitoring an input data stream of the ML system 200 for data drift detection, and initializes a drift adaptation method selector 240, which is responsible for selecting a drift adaptor 280 that fulfills the drift handling requirements. The feature monitor 220 monitors the distribution changes of the AI/ML model input data, while the model monitor 230 monitors the model accuracy drops.

The feature monitor 220 may detect data drift based on a distribution change of the input data and determines a type and a range of data drift. The feature monitor 220 may detect data drift based on a distribution change of the input data by mapping at least one training window to at least one feature and at least one corresponding drift time of the at least one feature, detecting whether at least one feature is drifting during at least one data window, the at least one data window being based at least in part on the at least one training window that is mapped to the at least one feature, estimating at least one next value and a distribution of at least one feature based on the input data stream, and predicting whether at least one feature is drifting based at least in part on at least one predetermined drift pattern and the estimated next value and the distribution. The feature monitor 220 may determine the type of data drift by predicting the data drift in the input data stream, wherein the at least one predetermined drift pattern includes one or more of a sudden drift pattern, a gradual drift pattern, an incremental drift pattern and a reoccurring drift pattern. The feature monitor 220 may determine the range of data drift by determining whether an amount of the at least one of the detected data drift and the predicted data drift at least meets or exceeds a predetermined drift threshold.

The model monitor 230 detects data drift based on a drop in accuracy of a first trained ML model 250. The model monitor 230 may detect data drift based on a drop in accuracy of the first trained ML model 250 using one or more of: Cumulative Sum (CUSUM) method, Adaptive Window (ADWIN) method, Early Drift Detection Method (EDDM), and Fast Hoeffding Drift Detection Method (FHDDM).

The feature monitor 220 and the model monitor 230 work together, and a data drift alert is issued only when both monitors detect a drift. The feature monitor is also responsible for providing the data drift type and range information. The type of a drift may be obtained via an ML classifier that is trained in a supervised way to tell different drift patterns. The range of drift can be calculated by e.g., comparing the original and current data means and deviations.

If the feature monitor 220 and the model monitor 230 both detect data drift, the drift adaptation method selector 240 selects, from a drift adaptation method repository 270 storing a plurality of data drift adaptors, one of the data drift adaptors 280 based on the performance metrics requirements obtained, a type of the first trained ML model 250, and the determined type and range of data drift. Once a data drift is detected by the feature monitor 220 and the model monitor 230, a drift detection alert, together with the drift type and drift range, is sent to the drift adaptation method selector 240. The drift adaptation method selector 240 then collects the AI/ML model information and the edge site resource information from the AI/ML model 250 and the edge site monitor 260, respectively. Based on all the information, it searches and selects from the drift adaption method repository 270, the most appropriate drift adaptor 280. With reference to the ML system 200 of FIG. 2, the data compensation adaptor is selected based on, for example, a reoccurring drift being predicted. The selection process is the same as the selecting of any other adaptors using, for example, the policy-based RL logic as described in the present disclosure.

The drift adaption method repository 270 stores the executable drift adaptors and allows the drift adaptation method selector 240 to search for a drift adaptor by AI/ML model type and drift adaption method. For example, a ‘cnn-TL-1’ is searchable by keywords: convolutional neural network (CNN), transfer learning (TL) and layer 1 adjustment. The drift adaption method repository 270 can, for example, be distributed in multiple edge sites or be centrally located in a data center.

The selecting from the drift adaptation method repository 270 based on the performance metrics requirements obtained, a type of the first trained ML model 250, and the determined type and range of data drift may use reinforcement learning (RL) and the RL used may include Q-learning. The RL used may include policy-based RL and the selecting may include defining a first state and a second state for target accuracy, wherein, in the first state, the target accuracy is within a predetermined target accuracy tolerance range and, in the second state, the target accuracy is not within the predetermined target accuracy tolerance range, defining actions of selecting each one of the data drift adaptors from the plurality of data drift adaptors in the drift adaptation method repository 270, defining a reward function based on the target accuracy, time consumption, and resource consumption of the selected one of the data drift adaptors, and defining a policy function based on a probability distribution of taking each action. The selecting may further include (a) applying the policy function to provide the probability distribution of all actions, (b) performing the action with the highest probability, (c) applying the reward function to provide the reward value for the action performed, (d) updating the probability distribution of the policy function based on the reward value for the action performed, performing steps (a) to (d) until the policy converges; and selecting the data drift adaptor with the highest probability or, if the policy has not converged, continuing to perform steps (a) to (d) until expiration of a predetermined time period, after which the data drift adaptor with the highest probability is selected.

In the exemplary embodiment illustrated in FIG. 2, data compensation is the drift adaptation method or drift adaptor 280 selected. In this exemplary embodiment, neither the data collector nor the second trained ML model is required. The drift adaptor applies a function to the input data for model 250 in a way that the input data is back to the original (un-drifted) range. The examples of the function can be log, subtract, add, and the like.

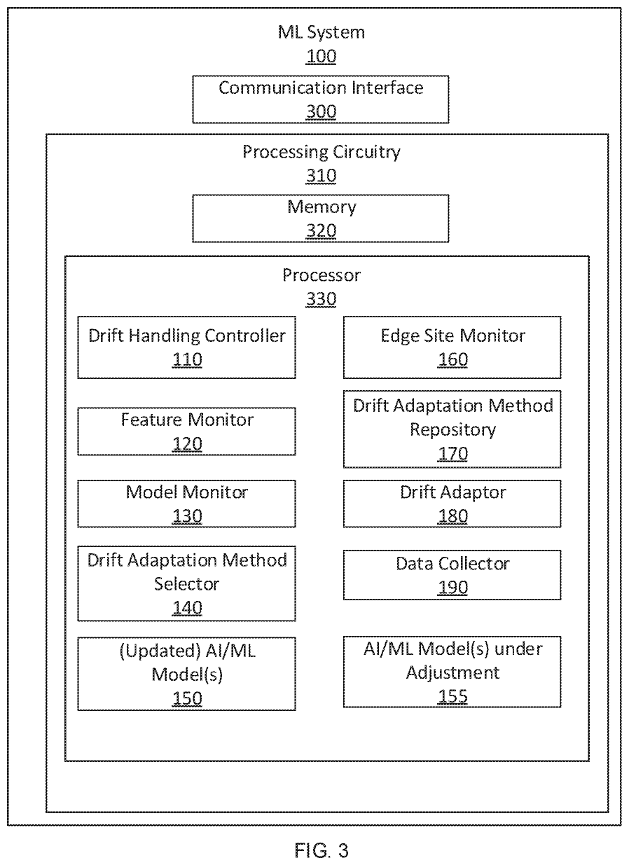

FIG. 3 is a block diagram illustrating an exemplary ML system architecture according to some embodiments. Referring now to FIG. 3, another example ML system 100 in accordance with the present disclosure is shown, including drift handling controller 110, feature monitor 120, model monitor 130, drift adaptation method selector 140, (updated) AI/ML model(s) 150, AI/ML model(s) under adjustment 155, edge site monitor 160, drift adaptation method repository 170, drift adaptor 180, and data collector 190. Note that although only a single drift handling controller 110, single feature monitor 120, single model monitor 130, single drift adaptation method selector 140, single (updated) AI/ML model(s) 150, single AI/ML model(s) under adjustment 155, single edge site monitor 160, single drift adaptation method repository 170, single drift adaptor 180, and single data collector 190 are shown in FIGS. 1 and 2 for convenience, the ML system 100 may include many more drift handling controllers 110, feature monitors 120, model monitors 130, drift adaptation method selectors 140, (updated) AI/ML models 150, AI/ML models under adjustment 155, edge site monitors 160, drift adaptation method repositories 170, drift adaptors 180, and data collectors 190.

The ML system 100 includes (and/or uses) a communication interface 300, processing circuitry 310, and memory 320. The communication interface 300 may include an interface configured to receive data (e.g., a live input data stream, streamed data/online data, non-stationary data, drift pattern, etc.), for which a data drift may be automatically handled in accordance with the methods of the embodiments of the present disclosure. The communication interface 300 may include an interface that transmits information, which may be automatically handled in accordance with the methods of the embodiments of the present disclosure. In some embodiments, the communication interface 300 may be formed as or may include, for example, one or more radio frequency (RF) transmitters, one or more RF receivers, and/or one or more RF transceivers, and/or may be considered a radio interface. In some embodiments, the communication interface 300 may include a wired interface, such as one or more network interface cards.

The processing circuitry 310 may include one or more processors 330 and memory, such as, the memory 320. In particular, in addition to a traditional processor and memory, the processing circuitry 310 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 330 may be configured to access (e.g., write to and/or read from) the memory 320, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

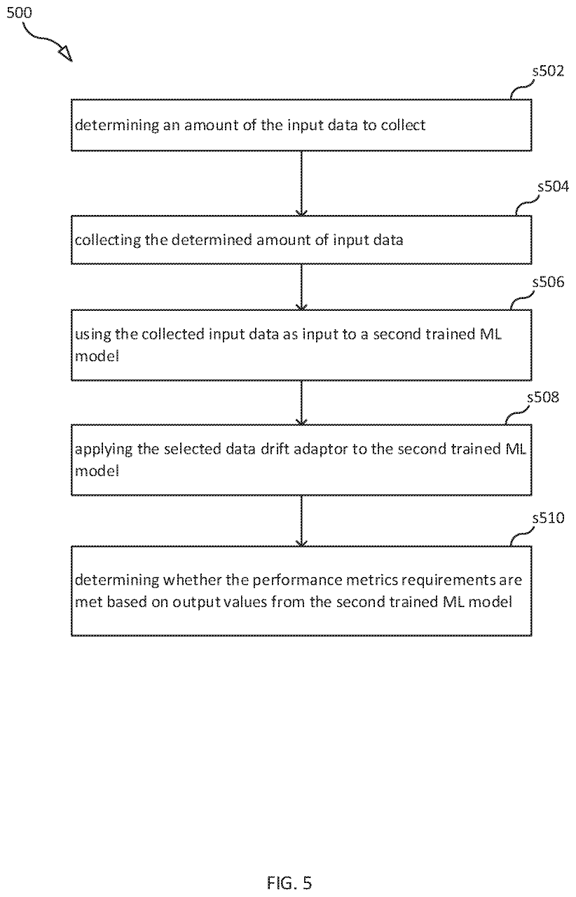

Thus, the ML system 100 may further include software stored internally in, for example, memory 320, or stored in external memory (e.g., storage resource in the cloud) accessible by the ML system 100 via an external connection. The software may be executable by the processing circuitry 310. The processing circuitry 310 may be configured to control any of the methods and/or processes described herein and/or to cause such methods, and/or processes to be performed, e.g., by the ML system 100. The memory 320 is configured to store data, programmatic software code and/or other information described herein. In some embodiments, the software may include instructions stored in memory 320 that, when executed by the processor 330, drift handling controller 110, feature monitor 120, model monitor 130, drift adaptation method selector 140, (updated) AI/ML model(s) 150, AI/ML model(s) under adjustment 155, edge site monitor 160, drift adaptation method repository 170, drift adaptor 180, and data collector 190, causes the processing circuitry 310 and/or configures the ML system 100 to perform the processes described herein with respect to the ML system 100 (e.g., processes described with reference to FIGS. 5-8 and/or any of the other flowcharts and descriptions).

Although FIG. 3 shows drift handling controller 110, feature monitor 120, model monitor 130, drift adaptation method selector 140, (updated) AI/ML model(s) 150, AI/ML model(s) under adjustment 155, edge site monitor 160, drift adaptation method repository 170, drift adaptor 180, and data collector 190, as being within a respective processor, it is contemplated that these elements may be implemented such that a portion of the elements is stored in a corresponding memory within the processing circuitry. In other words, the elements may be implemented in hardware or in a combination of hardware and software within the processing circuitry.

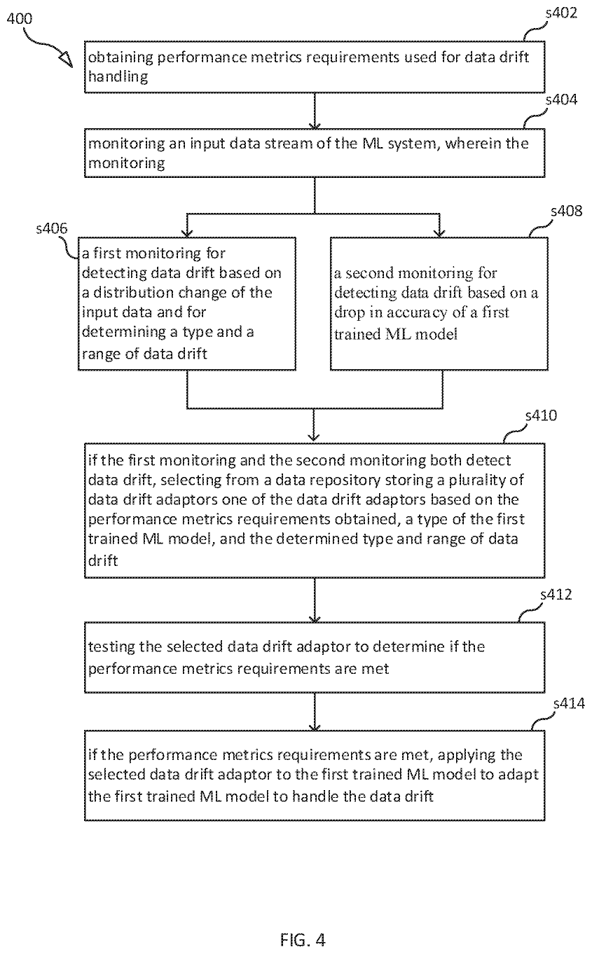

FIG. 4 is a flowchart illustrating a process 400 according to some embodiments. Process 400 may begin with step s402.

Step s402 comprises obtaining performance metrics requirements used for data drift handling.

Step s404 comprises monitoring an input data stream of the ML system. Step s406 comprises a first monitoring for detecting data drift based on a distribution change of the input data and for determining a type and a range of data drift. Step s408 comprises a second monitoring for detecting data drift based on a drop in accuracy of a first trained ML model.

Step s410 comprises, if the first monitoring and the second monitoring both detect data drift, selecting from a data repository storing a plurality of data drift adaptors one of the data drift adaptors based on the performance metrics requirements obtained, a type of the first trained ML model, and the determined type and range of data drift.

Step s412 comprises testing the selected data drift adaptor to determine if the performance metrics requirements are met.

Step s414 comprises, if the performance metrics requirements are met, applying the selected data drift adaptor to the first trained ML model to adapt the first trained ML model to handle the data drift.

FIG. 5 is a flow chart illustrating a process 500 for testing the selected data drift adaptor to determine if the performance metrics requirements are met according to some embodiments. Step s502 comprises determining an amount of the input data to collect.

Step s504 comprises collecting the determined amount of input data.

Step s506 comprises using the collected input data as input to a second trained ML model.

Step s508 comprises applying the selected data drift adaptor to the second trained ML model.

Step s510 comprises determining whether the performance metrics requirements are met based on output values from the second trained ML model.

### Drift Adaptation Method Selector

The ML system of embodiments of the present disclosure includes a drift adaptation method selector for automatically selecting a drift adaptation method from a drift adaptation method repository to fulfill the drift handling requirements set by, for example, an edge cloud operator. These requirements (KPIs) are, for example, (1) the maximum time used for drift adaptation (Tₘₐₓ), (2) the maximum amount of resources allocated for drift adaptation (Rₘₐₓ), (3) the maximum amount of dataset size used for adaptation (Dₘₐₓ), and (4) Model's target accuracy tolerance range (Aₜ). In addition to the KPIs, other parameters are also considered, such as, Type of Drift (ToD), Range of Drift (RoD), and type of running ML model (M).

### Policy-Based RL Selector

In embodiments of the present disclosure, a policy-based Reinforcement Learning (RL) method is used to learn to automatically select the most suitable drift adaptation method. The method allows an operator to flexibly update the adaptation policies and add new drift adaptation methods.

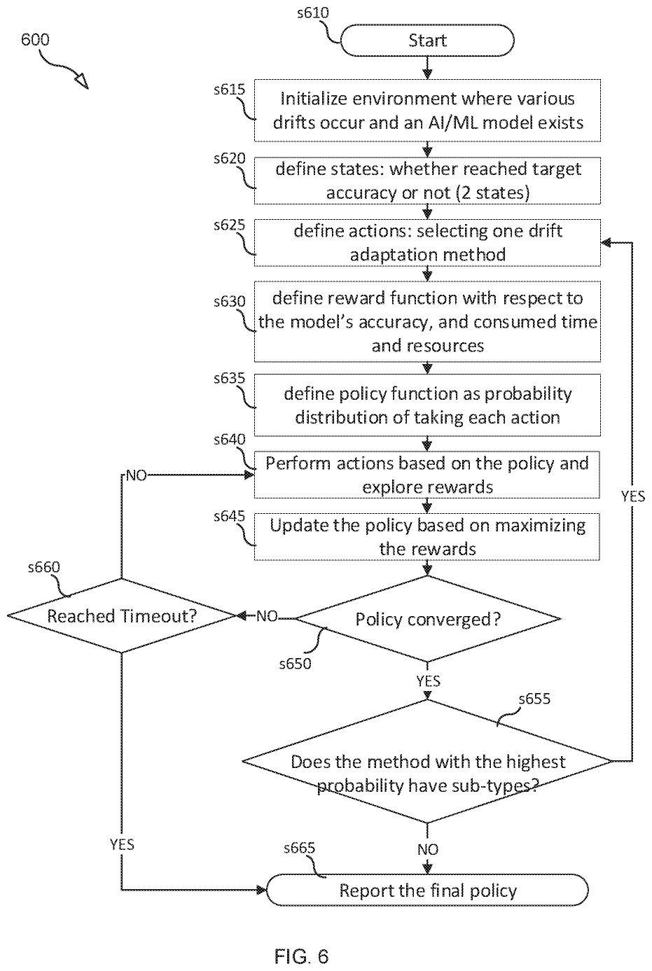

FIG. 6 is a flow chart illustrating a policy-based RL method used by the drift adaptation method selector for selecting a drift adaptation method. Process 600 begins with defining and initializing the environment, states, actions, reward functions, and policy function.

Regarding the environment, in some embodiments, there is an AI/ML model in this environment in which various types of drifts may occur that cause a model accuracy degradation. The agent is supposed to find the best drift adaptation method to compensate these drifts. It is assumed that a dataset with size Dₘₐₓ set by the edge cloud operator is available for adaptation.

Regarding the states, in some embodiments, two states are considered that indicate whether the agent has reached the target accuracy tolerance range (Aₜ) or not.

Regarding the actions, in some embodiments, the action is to select a drift adaptation method from a set of n available methods (i.e., a₁, . . . , aₙ).

Regarding the reward function, in some embodiments, the reward of action aᵢ at a given state (s) is a function of accuracy Aᵢ, and time consumption Tᵢ, and resource consumption Rᵢ of the adaptation method i:

$$R W ( s , {a}_{i} ) = {k}_{1} ( {A}_{i} - {A}_{t} ) - {k}_{2} ( {T}_{i} - {T}_{max} ) - {k}_{3} ( {R}_{i} - {R}_{max} ) \qquad ( 1 )$$

where Aₜ is the target accuracy, and Tₘₐₓ and Rₘₐₓ are the maximum time and resources available for adaptation. The k₁, k₂, and k₃ coefficients reflect how exceeding each limit (gaining the target accuracy and time and resource consumption limits) can penalize or promote the reward.

Regarding the policy function, in some embodiments, the policy returns a probability distribution over the set of actions ({a₁, . . . , aₙ}), given the state (S), and some parameters (θ). The probability of each action is indicated as {P₁, . . . , Pₙ} where Σᵢ₌₀ⁿPᵢ=1. The initial values of the probabilities can be set to e.g., a uniform distribution. The policy function I for adaptation method selector is given by:

$${π}_{θ} ( a \vert s ) = ( {P}_{1} , … , {P}_{n} ) \qquad ( 2 )$$

Given the defined states, actions, reward function and policy, starting from the initial state, the agent selects the action following the policy and explores the rewards. The probability distribution in the policy will be updated after exploring the rewards to increase the probability of selecting the method (taking the action) that results in a greater reward, and similarly to decrease the probability of selecting the methods resulting in less reward. This policy iteration will continue until the policy converges, or until a timeout is reached. If the actions (i.e. the adaptation method) include sub-category of methods, a new RL process will be executed for the sub-category of actions.

The final output of this method is the policy that tells the agent what action results in the highest reward, which is the equivalent to selecting the drift adaptation method, e.g., gaining the highest accuracy with the lowest time and resource consumption.

Referring now to FIG. 6, process 600 may begin with step s610, start.

Step s615 comprises initializing the environment where various drifts occur and an AI/ML model exists.

Step s620 comprises defining states: whether reached target accuracy or not (2 states).

Step s625 comprises defining actions: selecting one drift adaptation method.

Step s630 comprises defining a reward function with respect to the model's accuracy, and consumed time and resources.

Step s635 comprises defining a policy function as a probability distribution of taking each action.

Step s640 comprises performing actions based on the policy and exploring rewards.

Step s645 comprises updating the policy based on maximizing the rewards.

Step s650 comprises a determination of whether the policy converged. If the policy converged, then the process proceeds to step s655. If the policy has not converged, the process proceeds to step s660.

Step s655 comprises a determination of whether the method with the highest probability has sub-types. If there are sub-types, the process proceeds to step s625. If there are no sub-types, the process proceeds to step s665.

Step s660 comprises a determination of whether a timeout is reached. If a timeout is reached, then the process proceeds to step s665. If a timeout is not reached, the process proceeds to step s640.

Step s665 comprises report the final policy.

An exemplary embodiment with drift adaptation method selector, in accordance with the method of FIG. 6, is provided. The drift adaptation method repository, in connection with this exemplary embodiment, consists of four categories of methods, namely, retraining, ensemble learning, transfer learning (TL), and data compensation, and the TL category further includes ten sub-methods. The agent's action is to first select the most suitable method from one of the four adaptation methods. Assuming the four types of drifts (ToD) that can occur in the environment, the policy in this example will be defined as follows:

$${π}_{θ} ( a \vert s ) = \{ \begin{matrix}( {P}_{T 1} , {P}_{E 1} , {P}_{R 1} , {P}_{D 1} ) , & ToD = Abrupt \\ ( {P}_{T 2} , {P}_{E 2} , {P}_{R 2} , {P}_{D 2} ) , & ToD = Gradual \\ ( {P}_{T 3} , {P}_{E 3} , {P}_{R 3} , {P}_{D 3} ) , & ToD = Re - occurring \\ ( {P}_{T 4} , {P}_{E 4} , {P}_{R 4} , {P}_{D4} ) , & ToD = Incremental\end{matrix} \qquad ( 3 )$$

where (P_{T1}, P_{E1}, P_{R1}, P_{D1}) stand for probability of choosing TL, ensemble learning, retraining, data compensation, respectively, for the first policy where ToD is abrupt. Similarly, other policies for gradual, re-occurring, and incremental drifts were defined.

In accordance with the process of FIG. 6, the agent will learn the most suitable drift adaptation method to select when various types of drifts occur. For instance, if ToD=Abrupt and Rₘₐₓ and Tₘₐₓ are limited, the agent would learn the policy in which P_{T1} has the highest probability compared to the other methods (e.g., (P_{T1}=0.98, P_{E1}=0.01, P_{R1}=0.005, P_{D1}=0.005)), which means that TL is the most suitable method to be selected. The reason for learning this policy is that the agent receives higher rewards by selecting TL method given that TL consumes less time and resources and provides a closer accuracy to Aₜ.

In this exemplary embodiment, TL is a category and there are multiple instances of TL and each of them is suitable for a specific type of AI/ML models and represents a specific transfer learning scenario. For example, in the ten TL methods, ‘cnn-TL-1’ represents the method adjusting lower layer parameters of a CNN network. ‘DNN-TL-4’ represents the method adjusting last layers of deep neural network. In this scenario, the answer to the question “does the method have sub types” in FIG. 6 is ‘yes’ and a new RL process will be executed.

To choose a specific method in the TL category, the actions are set to the items in the list of TLs, and, for example, the range of drift (RoD), and Dₘₐₓ as new policy variables for method selection. Now, if the model M is CNN, and the Dₘₐₓ is less than e.g., 3000 samples and RoD is larger than e.g., 50%, the RL selection method would suggests 95% of probability to select ‘cnn-TL-1’ as the drift adaptation method, and thus ‘cnn-TL-1’ is selected.

In the case that the edge cloud operator, for example, adds a new drift adaptation method to the drift adaptation method repository, a new probability (e. g., Pₒ) can be added in the policy function. In the case that the operator, for example, changes its requirements (e.g., Dₘₐₓ), the drift adaptation method selector applies the updated parameters in the next selection procedures.

### Static Policy-Based Selector

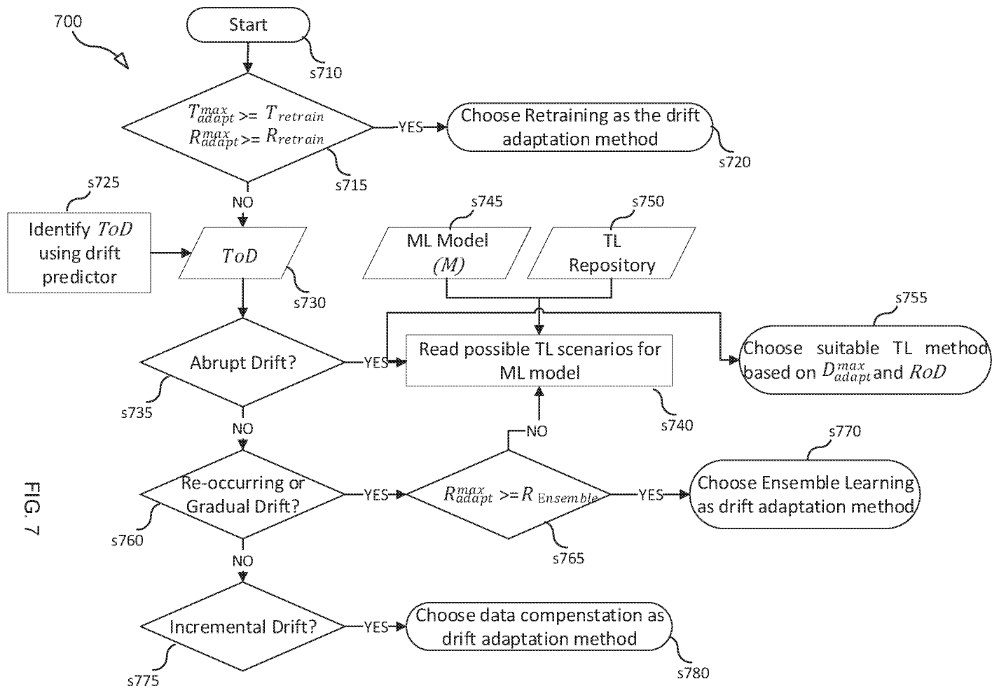

In an alternative embodiment, if an operator's requirements do not often change and the adaptation methods are stable, a static policy-based selector can be used. FIG. 7 is a flow chart illustrating a static policy-based method used by the drift adaptation method selector for selecting a drift adaptation method according to some embodiments.

Referring now to FIG. 7, process 700 may begin with step s710, start.

Step s715 comprises the following determination:

If both equations are satisfied, then the process proceeds to step s720. If not, then the process proceeds to step s730.

Step s720 comprises choosing retraining as the drift adaptation method.

Step s725 comprises identifying the type of drift (ToD) using the drift predictor.

Step s730 comprises the ToD identified.

Step s735 comprises a determination of whether the drift is an abrupt drift. If it is an abrupt drift, then the process proceeds to step s740. If not, then the process proceeds to step s760.

Step s740 comprises reading the possible transfer learning (TL) scenarios for the ML model.

Step s745 comprises the ML model (M) input to step s740.

Step s750 comprises the TL repository from which the TL scenarios are input to step s740.

Step s755 comprises choosing a suitable TL method based on D_{adapt}^{max} and RoD.

Step s760 comprises a determination of whether the drift is a re-occurring drift or a gradual drift. If the drift is a re-occurring drift or a gradual drift, then the process proceeds to step s765. If not, then the process proceeds to step s775.

Step s765 comprises the following determination:

If the equation is satisfied, then the process proceeds to step s770. If not, then the process proceeds to step s740.

Step s770 comprises choosing ensemble learning as the drift adaptation method.

Step s775 comprises a determination of whether the drift is an incremental drift. If the drift is an incremental drift, then the process proceeds to step s780.

Step s780 comprises choosing data compensation as the drift adaptation method.

### Data Collector

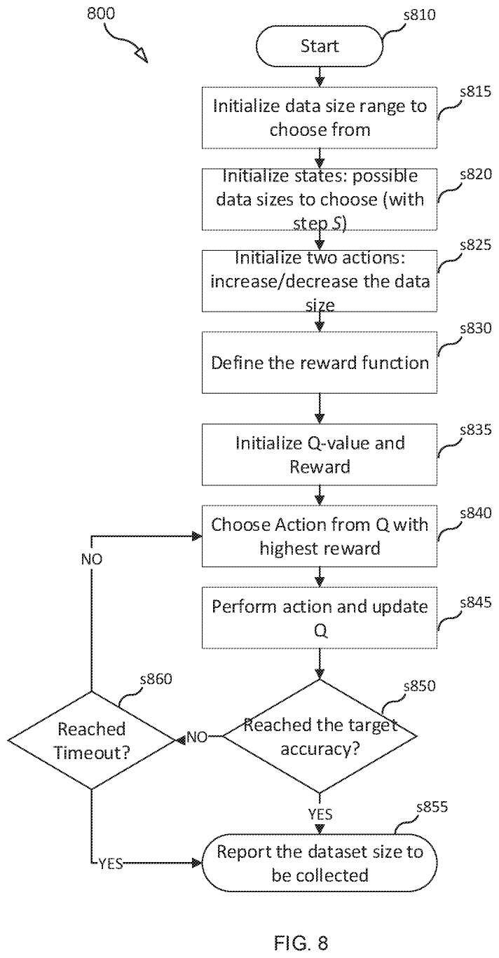

In embodiments of the present disclosure, a data collector is used to automatically learn the amount of data needed to be collected for commencing the drift adaptation procedure utilizing, for example, RL (Q-learning), and collect the data. The ML model is adapted given the collected data and achieves an accuracy as high as the original model in order for maintaining a persistent accuracy. FIG. 8 is a flow chart illustrating a process for data collection using Q-learning, according to some embodiments. In the exemplary process of the data collector as illustrated in FIG. 8, the first step of RL (Q-learning) is to define and initialize the states, actions, and reward functions.

Regarding the states, in some embodiments, the states are the data sizes with incremental/decremental interval S (e.g., 100). Regarding the actions, in some embodiments, there are two actions (i.e., increasing or decreasing data size). Regarding the reward function, in some embodiments, the reward function is a function of the gained accuracy using the collected data (A_{c}) and Aₜ defined as follow:

$$R W ( s ) = ( {A}_{c} - {A}_{t} ) \qquad ( 4 )$$

This reward function indicates that the actions which result in closer accuracies to the target accuracy, or a higher accuracy than the target accuracy get the top reward.

After the initializations of the reward and Q matrices, the exploration will begin and the action with the maximum reward will be chosen, and the values of the Q will be updated until either the target accuracy is reached or the timeout for training is met.

Referring now to FIG. 8, process 800 may begin with step s810, start.

Step s815 comprises initializing a data size range to choose from.

Step s820 comprises initializing states: possible data sizes to choose (with step S).

Step s825 comprises initializing two actions: increase/decrease the data size.

Step s830 comprises defining the reward function.

Step s835 comprises initializing Q-value and reward.

Step s840 comprises choosing action from Q with highest reward.

Step s845 comprises performing the action and updating Q.

Step s850 comprises a determination of whether the target accuracy has been reached. If it has, then the process proceeds to step s855. If not, then the process proceeds to step s860.

Step s855 comprises reporting the data set size to be collected.

Step s860 comprises a determination of whether a timeout is reached. If a timeout is reached, then the process proceeds to step s855. If a timeout is not reached, then the process proceeds to step s840.

### Edge Cloud Exemplary Implementation

A real-world edge cloud testbed utilizing Kubernetes was implemented for evaluating an embodiment of the present disclosure.

### A. Implementation Specifications

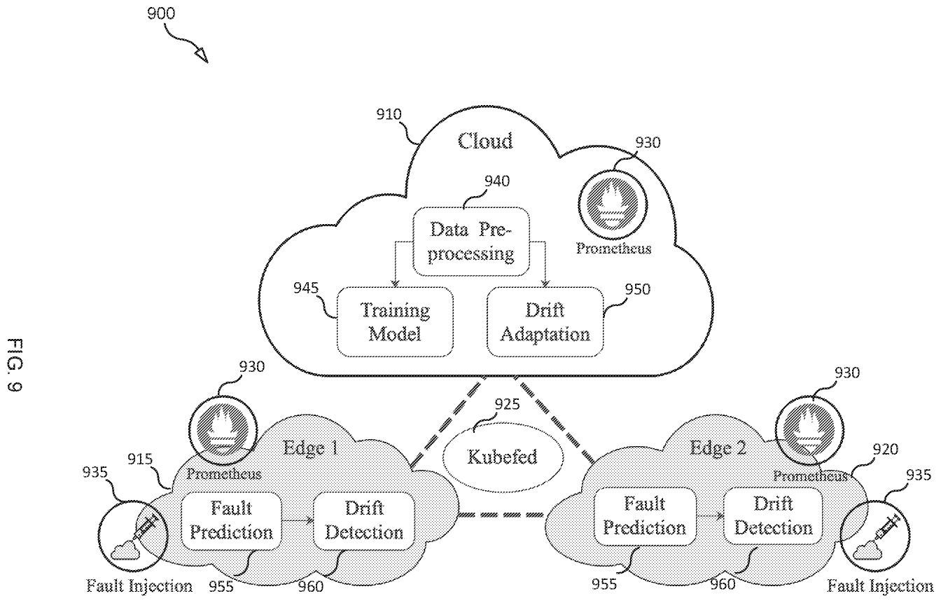

FIG. 9 illustrates an exemplary implementation in an edge cloud 900 for the ML system for automated handling of data drift according to some embodiments.
1) Lab Setup: FIG. 9 depicts a lab setup that consists of three Kubernetes clusters 910, 915, and 920 with 10 Virtual Machines (VMs) running Ubuntu 18.04. One cluster represents the central site 910 (i.e., data center) while the other two clusters 915, 920 are the edge sites. The central site cluster 910 has one master and three worker nodes, and a physical machine is connected to this site for training the models. The edge clusters 915, 920 have one master and two worker nodes. Kubefed 925 was used for Kubernetes federation. A CPU-intensive application is installed on all master nodes that generates traffic load, which increases the CPU and network load causing a drift in the data (i.e., performance metrics of the nodes) used for training the model. The architecture illustrated in FIG. 9 is for a small-scale setup. In larger scales, based on the capacity of edge nodes, it would be possible to move data pre-processing component 940, or the set of all components 940, 945, 950 into the edge nodes to avoid big data transfers over the network. Further details of the lab configurations are presented in Table I.

TABLE I
PARAMETER SETTINGS AND DEFAULT VALUES.

| Central Site | | Edge Site | |
|---|---|---|---|
| Parameters | Value | Parameters | Value |
| CPU | 4 × 4 core and | CPU | 3 × 4 cores |
| | 1 × Core i7-8700 | | |
| RAM | 5 × 16G | RAM | 2 × 8G and 1 × 16G |
| HDD | 4 × 100G and 1x1TB | HDD | 3 × 100G |

2) Monitoring and Data Collection: For monitoring the Kubernetes clusters and collecting data Prometheus 930 (see https://prometheus.io, accessed January 2021) was used. For each cluster 910, 915, 920, one instance of Prometheus 930 was installed. The data collection rate is 10 s, at which the node-level statistics of VMs (e.g., CPU, memory, network, etc.) were collected.

Fault Injection 935: CPU over-utilization and network congestion faults were injected to the edge nodes using Stress-ng (see https://wiki.ubuntu.com/Kernel/Reference/stress-ng, accessed January 2021) tool and Ping flood respectively. The fault injection 935 has an accumulative pattern which means that once the injection is started, it grows gradually in discrete increments over time. For instance, for the CPU over-utilization fault, the injection starts by stressing the CPU at 20% and increasing the utilization up to 40%, 60%, and 80%. Similarly, for the network congestion fault, pings were sent with intervals of 0.2 s, 0.1 s, 0.05 s, and then in flooding mode. Following A. Netti, Z. Kiziltan, O. Babaoglu, A. Sirbu, A. Bartolini, and A. Borghesi, “A machine learning approach to online fault classification in HPC systems,” Future Generation Computer Systems, vol. 110, pp. 1009-1022 September 2020, the duration of the injection follows a Normal distribution (with a mean of 30 s and standard deviation of 6 s for each step in this implementation), while inter-arrival time of fault injections follows an exponentiated Weibull distribution (with a shape parameter 10 and shifted value of 120 s in this implementation).

Implementation and Coding Tools: Python 3.8 was used for implementing all the entities. For building and training the neural network models, Keras (with Tensorflow backend) and Scikit-learn libraries were used. Drift detection methods are implemented using Scikit-multiflow library (see https://scikit-multiflow.github.io, accessed January 2021) and Tornado framework (see Tornado framework,” https://github.com/alipsgh/tornado, accessed January 2021; and A. Pesaranghader, H. Viktor, and E. Paquet, “Reservoir of diverse adaptive learners and stacking fast hoeffding drift detection methods for evolving data streams,” Machine Learning, vol. 107, no. 11, pp. 1711-1743 November 2018).

### B. Experimental Results

The experimental results of fault prediction as well as the drift detection and adaptation methods were evaluated and compared. Furthermore, the effectiveness of the ML system of the present disclosure in the presence of concept drift is illustrated by presenting its persistent accuracy. One week of data was collected for these experiments.
1) Fault Prediction Results: The purpose of this experiment is to compare the accuracy of the trained prediction models to find the best model for each type of fault. Two types of LSTMs (i.e., simple LSTM and Stacked LSTM), two types of CNNs (i.e., simple CNN and Multi-Channel CNN (MCCNN)), and a CNN-LSTM model were trained using CPU over-utilization and network congestion fault data. 10 features were selected using RFE. The input window is set to 12 samples, and the output window (prediction duration) is 6 samples. This means that 12 previous samples were evaluated to forecast 6 samples ahead which is equivalent to predicting one minute ahead in the case that the data collection rate is 10 s. The first two days out of one week of data were used for training and evaluating the models, and the dataset was split into training and testing data with a ratio of 80% and 20%, respectively. Moreover, the hyper-parameters of our considered models are optimized using TPE.

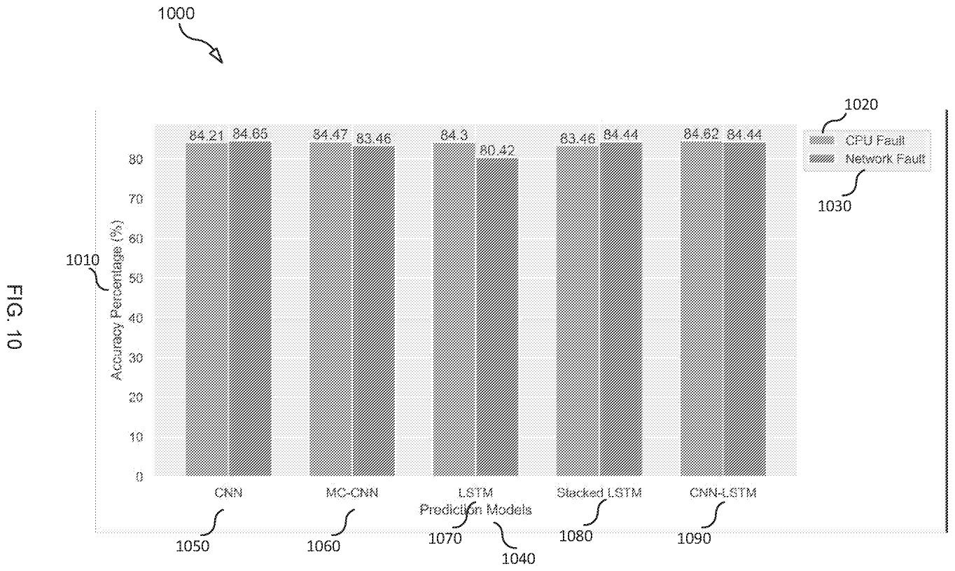

FIG. 10 is a bar chart 1000 illustrating the accuracy of different trained ML prediction models used for the exemplary implementation of the ML system in an edge cloud according to some embodiments. FIG. 10 illustrates the accuracy 1010 of the trained models 1040 for CPU 1020 and network 1030 faults, and Table II presents the training times for each model.

TABLE II
TRAINING TIME OF CONSIDERED ML
MODELS ON TWO DAYS OF DATA.

| | | MC- | | Stacked | CNN- |
|---|---|---|---|---|---|
| Model | CNN | CNN | LSTM | LSTM | LSTM |
| CPU Fault | 160.6 | 99.3 | 160.6 | 135.8 | 334.1 |
| Training Time (s) | | | | | |
| Network Fault | 125.8 | 149.6 | 993.3 | 1951.1 | 989.0 |
| Training Time (s) | | | | | |

As illustrated in FIG. 10, all models have almost comparable prediction accuracies. For CPU fault data 1020, the CNN-LSTM 1090 has the highest accuracy of 84.62% while for the network fault data 1030, the CNN model 1050 has the highest accuracy of 84.65%. However, the training time of models are diverse. According to Table II, for both types of faults, the lowest training time is for CNNs 1050 and the highest training time is for CNN-LSTM 1090, LSTM 1070, and Stacked LSTM 1080, which is due to the recursive characteristics of LSTM layers.

Drift Detection Results: Next, the performance of CUSUM, FHDDM, ADWIN, and EDDM drift detection methods was compared. For this purpose, the last 5 days out of one week of data were used to detect the possible drifts that happened during this period for both CPU and network fault data. For predicting the CPU fault, the CNN-LSTM model was used since it had the highest accuracy whereas for predicting the network fault, the CNN model was used. Then, four drift detection methods were applied on the predictions of these models.

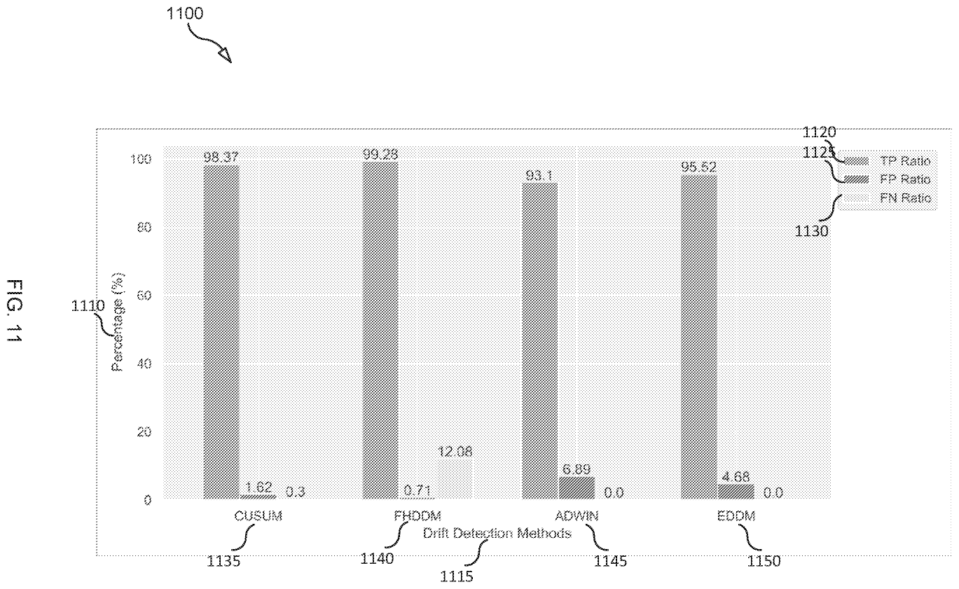

FIG. 11 is a bar chart 1100 illustrating the average detection delay 1110 of different drift detection methods 1115 used for the exemplary implementation of the ML system in an edge cloud according to some embodiments. FIG. 11 depicts the True Positive (TP) Ratio 1120, False Positive (FP) Ratio 1125, and False Negative (FN) Ratio 1130 of each method considering the detection of drifts on both CPU and network faults. TP ratio 1120 is the ratio of correct drift detections to the total detections of the method. Similarly, FP ratio 1125 is the ratio of false drift detections to the total detections. FN ratio 1130 is the ratio of missed drifts to the total number of drifts occurred. The drift detection method should detect the drifts as soon as they occur so the process of adaptation begins as close as possible to the drift time. Thus, Table III presents the average detection delay of CPU and network fault for each method.

TABLE III
AVERAGE DRIFT DETECTION DELAY
OF EACH DRIFT DETECTION METHOD.

| Method | CUSUM | FHDDM | ADWIN | EDDM |
|---|---|---|---|---|
| Detection Delay | 120 | 95.5 | 588.5 | 15.5 |
| (Data Samples) | | | | |

According to FIG. 11, the FHDDM 1140 and CUSUM 1135 methods have comparable TP Ratios of 99.28% and 98.37% in detecting the drifts. However, the ideal method should not have lots of FPs or false alarms, since the false detection will trigger the drift adaptation process which will consume unnecessary resources. Moreover, the ideal method should not have a high FN ratio either, which means that it should not miss the occurrence of any drifts. Considering the FP and FN ratio of FHDDM 1140 and CUSUM 1135, CUSUM 1135 is a better method due to the lower FN ratio. Considering the detection delay results shown in Table III, FHDDM 1140 has a lower average drift detection delay of 95.5 data samples compared to 120 data samples delay of CUSUM 1135. Here, since not missing the drifts (i.e., a lower FN ratio) is a top priority, CUSUM 1135 was chosen as the best method.

Drift Adaptation Results: After detecting the drift, the prediction model is adapted to the drift. In this experiment, the results of three different transfer learning scenarios are compared on CNN-LSTM prediction model for the CPU fault data, and CNN prediction model for network fault data due to their high accuracy. In the first scenario (called TL-1), after a drift occurs, new data is gathered and the lower layers of the prediction model are fine-tuned using this data. Similarly, in the second scenario (called TL2), the upper layers of the prediction model are fine-tuned, and in the third scenario (called TL-3), the whole prediction model is fine-tuned using the recently gathered data. The size of the gathered data is also an important factor in these experiment since it determines the amount of time waiting to obtain the adapted model after the drift occurrence. The data size gathered is set to adapt the CPU fault prediction model to 5300 samples, and the network fault prediction model to 5400, which is the amount of data gathered until the accuracy of the adapted prediction model is nearly equal to the original accuracy of the model. For the sake of comparison, the retraining drift adaptation method was implemented and evaluated.

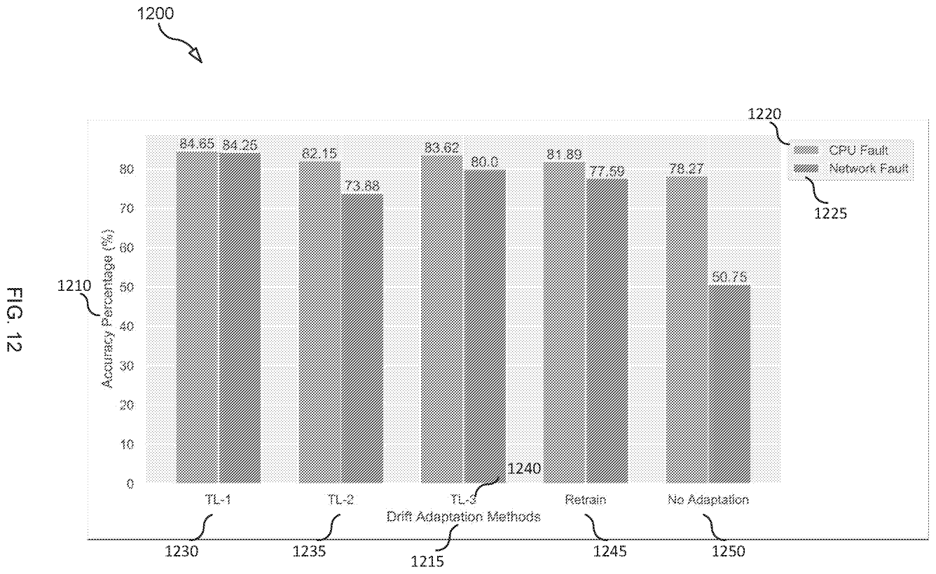

FIG. 12 is a bar chart 1200 illustrating the accuracy of different trained ML prediction models after adaptation used for the exemplary implementation of the ML system in an edge cloud according to some embodiments. FIG. 12 illustrates the accuracy of the prediction model 1210 after each adaptation scenario is applied for CPU 1220 and network 1225 fault models. Moreover, Table IV presents the adaptation time for each adaptation scenario.

TABLE IV
ADAPTATION TIME FOR EACH ADAPTATION SCENARIO.

| Method | TL-1 | TL-2 | TL-3 | Retraining |
|---|---|---|---|---|
| CPU Fault | 98.6 | 72.0 | 115.5 | 124.5 |
| Adaptation Time (s) | | | | |
| Network Fault | 33.7 | 18.5 | 37.5 | 39.5 |
| Adaptation Time (s) | | | | |

According to FIG. 12, for both CPU fault 1220 and network fault 1225, TL-1 1230 has the highest accuracy of 84.65% and 84.25% respectively, which are close to the original accuracy of the prediction models. In FIG. 12, if no adaptation method is applied, the prediction accuracy for CPU fault 1220 and network fault 1235 would drop to 78.27% and 50.75%, respectively, which illustrates the effectiveness of the drift adaptation method. Retraining 1245 and TL-2 1235 have the lowest accuracies since the gathered data is not sufficient to train a model from scratch in case of retraining, and TL-2 1235 preserves the weights of lower layers, which should be updated since they extract general features of data which has been drifting. According to Table IV, TL methods 1230, 1235, 1240 have lower adaptation time compared to retraining, however, the difference is not that significant for TL-1 1230 and TL-3 1240.

Accuracy of the Proposed System Over Time: In this experiment, the best performing drift detection and adaptation methods are brought together to see the performance of the ML system of the present disclosure in the presence of concept drift and compare it to a system without any drift handling entity. The system is evaluated on the last five days of network fault data, and monitor the accuracy of network fault prediction model. CNN is used for network fault predictions, CUSUM for detecting the drifts and TL-1 for adapting the model to the occurred drift.

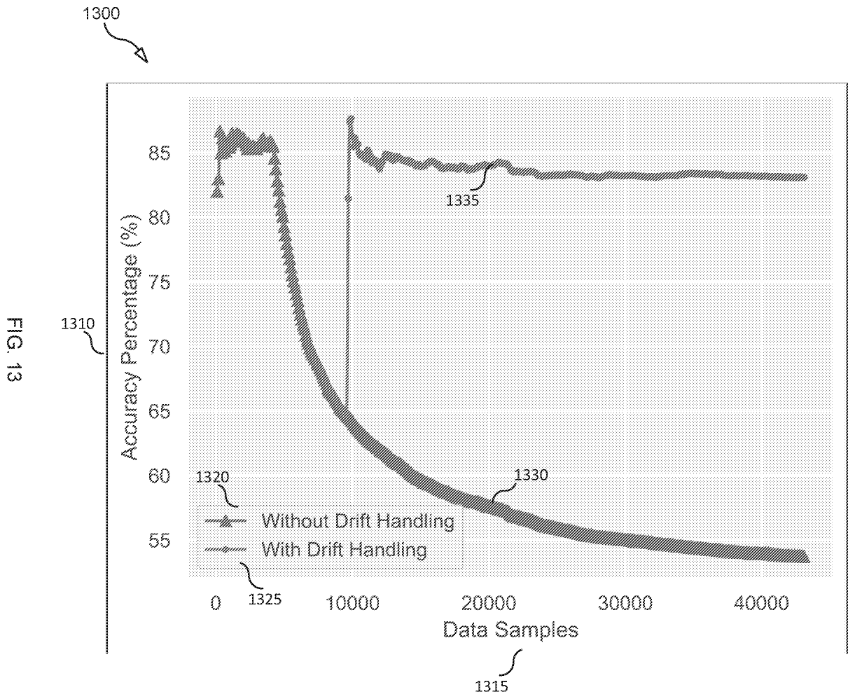

FIG. 13 is a graph 1300 illustrating the accuracy 1310 over time of the exemplary implementation of the ML system in an edge cloud according to some embodiments, as compared to an edge cloud without the ML system. FIG. 13 depicts the persistent accuracy 1310 of the ML system in five days while drifts happen. As illustrated in FIG. 13, a drift occurs around the data sample 4000 and the accuracy of the prediction model 1330 starts to drop. During this experiment, one sudden drift is detected. The CUSUM drift detection method detects the occurrence of this drift and starts gathering data (for 5400 samples), and then TL-1 drift adaptation method starts fine-tuning the prediction model. Around the data sample 10000, the adaptation process is complete and the accuracy of the prediction model 1335 is increased to approximately its original accuracy of 84.65%. However, the accuracy of the model that was not adapted after the drift decreases to nearly 54% after the drift happens. FIG. 13 shows the effectiveness of our proposed auto-adaptive fault prediction system in the presence of concept drift, which can maintain a persistent accuracy during our 5-day experiment.

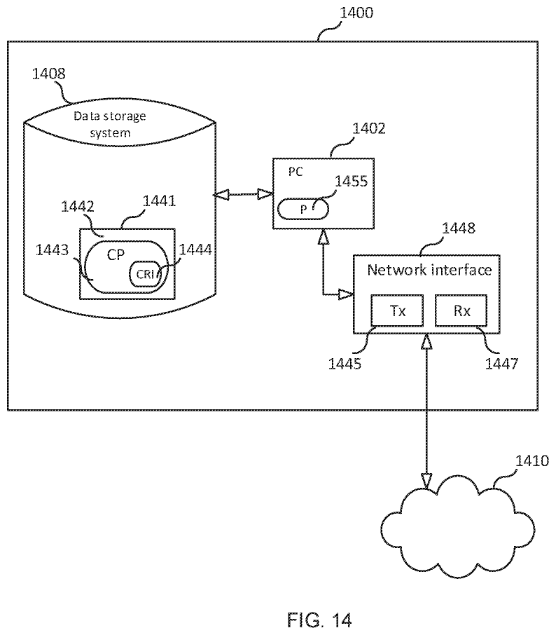

FIG. 14 is a block diagram of an apparatus 1400, according to some embodiments. Apparatus 1400 may be a network node, such as a base station, a computer, a server, a wireless sensor device, or any other unit capable of implementing the embodiments disclosed herein. As shown in FIG. 14, apparatus 1400 may comprise: processing circuitry (PC) 1402, which may include one or more processors (P) 1455 (e.g., a general purpose microprocessor and/or one or more other processors, such as an application specific integrated circuit (ASIC), field-programmable gate arrays (FPGAs), and the like), which processors 1455 may be co-located in a single housing or in a single data center or may be geographically distributed (i.e., apparatus 1400 may be a distributed apparatus); a network interface 1448 comprising a transmitter (Tx) 1445 and a receiver (Rx) 1447 for enabling apparatus 1400 to transmit data to and receive data from other nodes connected to network 1410 (e.g., an Internet Protocol (IP) network) to which network interface 1448 is connected; and a local storage unit (a.k.a., “data storage system”) 1408, which may include one or more non-volatile storage devices and/or one or more volatile storage devices. In embodiments where PC 1402 includes a programmable processor, a computer program product (CPP) 1441 may be provided. CPP 1441 includes a computer readable medium (CRM) 1442 storing a computer program (CP) 1443 comprising computer readable instructions (CRI) 1444. CRM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes apparatus 1400 to perform steps described herein (e.g., steps described herein with reference to the flow charts). In other embodiments, apparatus 1400 may be configured to perform steps described herein without the need for code. That is, for example, PC 1402 may consist merely of one or more ASICs. Hence, the features of the embodiments described herein may be implemented in hardware and/or software.

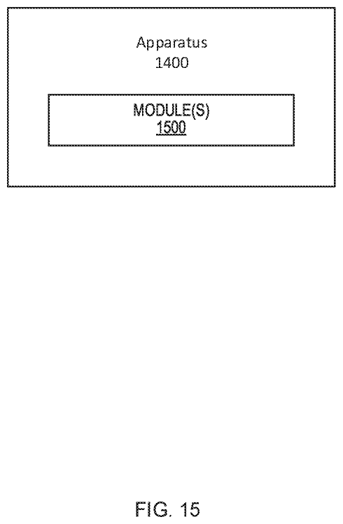

FIG. 15 is a schematic block diagram of the apparatus 1400 according to some other embodiments. The apparatus 1400 includes one or more modules 1500, each of which is implemented in software. The module(s) 1500 provide the functionality of apparatus 1400 described herein (e.g., steps described herein with reference to the flow charts).

According to some embodiments, apparatus 1400 may be a network node configured for automated handling of data drift in a network using a ML system, and the modules 1500 providing the functionality of apparatus 1400 may include a drift handling controller module for obtaining performance metrics requirements, such as drift handling requirements' key performance indicators (KPIs) from, for example, an operator, for initializing a feature monitor module and a model monitor module for monitoring an input data stream of the ML system for data drift detection, and for initializing a drift adaptation method selector for upcoming data drift adaptation.

The modules 1500 providing the functionality of apparatus 1400 may further include the feature monitor module for detecting data drift based on a distribution change of the input data and for determining a type and a range of data drift. The feature monitor module may detect data drift based on a distribution change of the input data by mapping at least one training window to at least one feature and at least one corresponding drift time of the at least one feature, detecting whether at least one feature is drifting during at least one data window, the at least one data window being based at least in part on the at least one training window that is mapped to the at least one feature, estimating at least one next value and a distribution of at least one feature based on the input data stream, and predicting whether at least one feature is drifting based at least in part on at least one predetermined drift pattern and the estimated next value and the distribution. The feature monitor module may determine the type of data drift by predicting the data drift in the input data stream, wherein the at least one predetermined drift pattern includes one or more of a sudden drift pattern, a gradual drift pattern, an incremental drift pattern and a reoccurring drift pattern. The feature model monitor may determine the range of data drift by determining whether an amount of the at least one of the detected data drift and the predicted data drift at least meets or exceeds a predetermined drift threshold.

The modules 1500 providing the functionality of apparatus 1400 may further include the model monitor module for detecting data drift based on a drop in accuracy of a first trained ML model, including detecting data drift based on a drop in accuracy of the first trained ML model using one or more of: Cumulative Sum (CUSUM) method, Adaptive Window (ADWIN) method, Early Drift Detection Method (EDDM), and Fast Hoeffding Drift Detection Method (FHDDM).

The modules 1500 providing the functionality of apparatus 1400 may further include the drift adaptation method selector module for selecting from a data repository storing a plurality of data drift adaptors, if the first monitoring and the second monitoring both detect data drift, one of the data drift adaptors based on the performance metrics requirements obtained, a type of the first trained ML model, and the determined type and range of data drift. The selecting from a data repository based on the performance metrics requirements obtained, a type of the first trained ML model, and the determined type and range of data drift may use reinforcement learning (RL) and the RL used may include Q-learning. The RL used may include policy-based RL and the selecting may include defining a first state and a second state for target accuracy, wherein, in the first state, the target accuracy is within a predetermined target accuracy tolerance range and, in the second state, the target accuracy is not within the predetermined target accuracy tolerance range, defining actions of selecting each one of the data drift adaptors from the plurality of data drift adaptors in the data repository, defining a reward function based on the target accuracy, time consumption, and resource consumption of the selected one of the data drift adaptors, and defining a policy function based on a probability distribution of taking each action. The selecting may further include (a) applying the policy function to provide the probability distribution of all actions, (b) performing the action with the highest probability, (c) applying the reward function to provide the reward value for the action performed, (d) updating the probability distribution of the policy function based on the reward value for the action performed, performing steps (a) to (d) until the policy converges; and selecting the data drift adaptor with the highest probability or, if the policy has not converged, continuing to perform steps (a) to (d) until expiration of a predetermined time period, after which the data drift adaptor with the highest probability is selected.

The modules 1500 providing the functionality of apparatus 1400 may further include a data collector module for testing the selected data drift adaptor to determine if the performance metrics requirements are met. The testing may include determining an amount of the input data to collect, collecting the determined amount of input data, using the collected input data as input to a second trained ML model, applying the selected data drift adaptor to the second trained ML model, and determining whether the performance metrics requirements are met based on output values from the second trained ML model. Determining an amount of the input data to collect may include using RL and initializing a data size range, initializing states, each state corresponding to one candidate data size of a plurality of candidate data sizes within the data size range, initializing a first action of increasing the data size and a second action of decreasing the data size, and defining a reward function based on a gained accuracy using collected data and target accuracy. Determining an amount of the input data to collect may further include (a) based on the reward value in Q, determining whether to perform the first action or the second action; (b) selecting one action; (c) update the reward values in Q for the selected action, performing steps (a) to (c) for each candidate data size, and identifying the candidate data size with the highest reward value above a predetermined threshold reward value for the amount of data to be collected or, if no reward value is above the predetermined threshold value, continuing to perform steps (a) to (c) for each candidate data size until expiration of a predetermined time period, after which the candidate data size with the highest reward value is identified as the data size for the amount of data to be collected.

The functional components and modules disclosed herein are logical entities and, thus, can be realized and deployed in, for example, distributed cloud environments as, for example, containers, such as docker containers.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computer-implemented method for automated handling of data drift in a machine learning (ML) system including a plurality of trained ML models, the method comprising:
obtaining performance metrics requirements used for data drift handling;
monitoring an input data stream of the ML system, wherein the monitoring includes:
a first monitoring for detecting data drift based on a distribution change of the input data and for determining a type and a range of data drift; and
a second monitoring for detecting data drift based on a drop in accuracy of a first trained ML model;
if the first monitoring and the second monitoring both detect data drift, selecting from a data repository storing a plurality of data drift adaptors one of the data drift adaptors based on the performance metrics requirements obtained, a type of the first trained ML model, and the determined type and range of data drift;
testing the selected data drift adaptor to determine if the performance metrics requirements are met; and
if the performance metrics requirements are met, applying the selected data drift adaptor to the first trained ML model to adapt the first trained ML model to handle the data drift.

2. The method according to claim 1, wherein the testing includes:
determining an amount of the input data to collect;
collecting the determined amount of input data;
using the collected input data as input to a second trained ML model;
applying the selected data drift adaptor to the second trained ML model; and
determining whether the performance metrics requirements are met based on output values from the second trained ML model.

3. The method according to claim 1, wherein the performance metrics requirements include one or more of: a maximum time used for drift adaptation, a maximum amount of resources allocated for drift adaptation, a maximum amount of dataset size used for drift adaptation, and an ML model target accuracy tolerance range.

4. The method according to claim 1, wherein the first monitoring for detecting data drift based on a distribution change of the input data includes:
mapping at least one training window to at least one feature and at least one corresponding drift time of the at least one feature;
detecting whether at least one feature is drifting during at least one data window, the at least one data window being based at least in part on the at least one training window that is mapped to the at least one feature;
estimating at least one next value and a distribution of at least one feature based on the input data stream; and
predicting whether at least one feature is drifting based at least in part on at least one predetermined drift pattern and the estimated next value and the distribution.

5. The method according to claim 4, wherein the first monitoring for determining the type of data drift includes:
predicting the data drift in the input data stream, wherein the at least one predetermined drift pattern includes one or more of a sudden drift pattern, a gradual drift pattern, an incremental drift pattern and a reoccurring drift pattern.

6. The method according to claim 5, wherein the first monitoring for determining the range of data drift includes:
determining whether an amount of the at least one of the detected data drift and the predicted data drift at least meets or exceeds a predetermined drift threshold.

7. The method according to claim 1, wherein the second monitoring for detecting data drift based on a drop in accuracy of the first trained ML model includes using one or more of: Cumulative Sum (CUSUM) method, Adaptive Window (ADWIN) method, Early Drift Detection Method (EDDM), and Fast Hoeffding Drift Detection Method (FHDDM).

8. The method according to claim 2, wherein selecting from the data repository one of the data drift adaptors based on the performance metrics requirements obtained, the type of the first trained ML model, and the determined type and range of data drift includes using reinforcement learning (RL).

9. The method according to claim 8, wherein the RL used includes policy-based RL and the selecting includes:
defining a first state and a second state for target accuracy, wherein, in the first state, the target accuracy is within a predetermined target accuracy tolerance range and, in the second state, the target accuracy is not within the predetermined target accuracy tolerance range;
defining actions of selecting each one of the data drift adaptors from the plurality of data drift adaptors in the data repository;
defining a reward function based on the target accuracy, time consumption, and resource consumption of the selected one of the data drift adaptors; and
defining a policy function based on a probability distribution of taking each action.

10. The method according to claim 9, wherein the selecting further includes:
(a) applying the policy function to provide the probability distribution of all actions;
(b) performing the action with the highest probability;
(c) applying the reward function to provide the reward value for the action performed;
(d) updating the probability distribution of the policy function based on the reward value for the action performed;
performing steps (a) to (d) until the policy converges; and
selecting the data drift adaptor with the highest probability or, if the policy has not converged, continuing to perform steps (a) to (d) until expiration of a predetermined time period, after which the data drift adaptor with the highest probability is selected.

11. The method according to claim 8, wherein the RL used includes Q-learning.

12. The method according to claim 10, wherein the reward function is carried out according to:
$$R W ( s , {a}_{i} ) = {k}_{1} ( {A}_{i} - {A}_{t} ) - {k}_{2} ( {T}_{i} - {T}_{max} ) - {k}_{3} ( {R}_{i} - {R}_{max} )$$
where:
RW refers to reward value;
s refers to a given state;
aᵢ refers to the action;
Aᵢ refers to accuracy of the adaptation method i;
Aₜ refers to target accuracy;
k₁, k₂, and k₃ coefficients refer to how exceeding each limit (gaining the target accuracy and time and resource consumption limits) can penalize or promote the reward;
Tᵢ refers to time consumption;
Tₘₐₓ refers to maximum time available for adaptation;
Rₘₐₓ refers to maximum resources available for adaptation; and
Rᵢ refers to resource consumption of the adaptation method i.

13. The method according to claim 10, wherein the policy function is carried out according to:
$${π}_{θ} ( a \vert s ) = ( {P}_{1} , … , {P}_{n} )$$
where:
π refers to policy function;
a refers to an action;
s refers to a given state; and
{P₁, . . . , Pₙ} where Σᵢ₌₀ⁿPᵢ=1 refers to the probability of each action.

14. The method according to claim 2, wherein determining an amount of the input data to collect includes using reinforcement learning (RL) and the determining includes:
initializing a data size range;
initializing states, each state corresponding to one candidate data size of a plurality of candidate data sizes within the data size range;
initializing a first action of increasing the data size and a second action of decreasing the data size; and
defining a reward function based on a gained accuracy using collected data and target accuracy.

15. The method according to claim 14, wherein determining an amount of the input data to collect further includes:
(a) based on the reward value in Q, determining whether to perform the first action or the second action;
(b) selecting one action;
(c) update the reward values in Q for the selected action;
performing steps (a) to (c) for each candidate data size; and
identifying the candidate data size with the highest reward value above a predetermined threshold reward value for the amount of data to be collected or, if no reward value is above the predetermined threshold value, continuing to perform steps (a) to (c) for each candidate data size until expiration of a predetermined time period, after which the candidate data size with the highest reward value is identified as the data size for the amount of data to be collected.

16. The method according to claim 15, wherein the reward function is carried out according to:
$$R W ( s ) = ( {A}_{c} - {A}_{t} )$$
where:
RW refers to reward value;
s refers to a given state;
A_{c} refers to accuracy achieved with the data collected; and
Aₜ refers to target accuracy.

17. The method according to claim 14, wherein the RL includes Q-learning.

18. (canceled)

19. A machine learning system comprising:
processing circuitry; and
a memory containing instructions executable by the processing circuitry for automated handling of data drift in a machine learning (ML) system including a plurality of trained ML models, the machine learning system operative to:
obtain performance metrics requirements used for data drift handling;
monitor an input data stream of the ML system, wherein the monitoring includes:
a first monitoring for detecting data drift based on a distribution change of the input data and for determining a type and a range of data drift; and
a second monitoring for detecting data drift based on a drop in accuracy of a first trained ML model;
if the first monitoring and the second monitoring both detect data drift, select from a data repository storing a plurality of data drift adaptors one of the data drift adaptors based on the performance metrics requirements obtained, a type of the first trained ML model, and the determined type and range of data drift;
test the selected data drift adaptor to determine if the performance metrics requirements are met; and
if the performance metrics requirements are met, apply the selected data drift adaptor to the first trained ML model to adapt the first trained ML model to handle the data drift.

20.-35. (canceled)

36. A network node configured for automated handling of data drift in a network using a machine learning (ML) system according to claim 19.

37. A computer program product comprising a non-transitory computer readable medium storing a computer program comprising instructions which, when executed by processing circuitry, causes the processing circuitry to perform the method of claim 1.

38. (canceled)
